(19) United States
(12) Patent Application Publication
(10) Pub. No.: US 2008/0059979 A1
(43) Pub. Date: Mar. 6, 2008

(54) Control Device and Development System Thereof

(75) Inventors: Koji HASHIMOTO, Hitachinaka (JP); Yuichiro Morita, Hitachi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Chiyoda-ku (JP)

(21) Appl. No.: 11/835,804

(22) Filed: Aug. 8, 2007

(30) Foreign Application Priority Data
Aug. 31, 2006 (JP) 2006-235873

(51) Int. Cl. G06F 13/14

(52) U.S. Cl. 719/321

(57) ABSTRACT

There is chosen a software configuration in which a communication driver has a function of outputting received data to the input information conversion part of a sensor driver and an input information conversion part outputs the same data to an application program in a format enabling processing by the application program. Also, there is chosen a software configuration in which an output information conversion part is provided in an actuator driver; the application program outputs the same data to the output information conversion part; and the output information conversion part outputs the same data to the communication driver in a format enabling transmission through communication.

### BACKGROUND OF THE INVENTION

1. Field of the Invention

The present invention is concerned with a control device and is related to a software configuration and a generating method therefor, for building, with few man-hours, software implementing e.g. distributed processing.

Further, the present invention can be applied to each and every system connecting a plurality of control units with a network and controlling objects of control while operating cooperatively by carrying out transmission and reception of data.

2. Description of the Related Art

Since some time ago, there have, in electronic control devices such as for vehicle control, been used microcomputers incorporating a CPU (Central Processing Unit), a ROM (Read Only Memory), a RAM (Random Access Memory), a signal input/output processing device, a communication processing device, and the like. The software with which the microcomputer is equipped consists of application programs carrying out control processing so that the control operations being aimed for can be performed; and device drivers controlling the signal input/output device and the communication control device. And then, in recent years, there has progressively been implemented distributed control of the entire control object (e.g. an entire vehicle) while doing cooperative work by connecting a plurality of electronic control devices with a network and carrying out transmission and reception of data. However, software carrying out such distributed control is generally complex and large-scale and requires a very large number of development man-hours.

As a configuration scaling back the number of development man-hours for distributed control software, there is known a software configuration (refer e.g. to JP-A-2001-270399) characterized in that the software consists of an application layer, an interface layer, a virtual sensor part, a virtual actuator part, and a communication driver and in that there are respectively provided an input information conversion part between the interface layer and the virtual sensor part and an output control part between the interface layer and the virtual actuator part. Together with implementing the positional transparency of a communication correspondent with respect to the application by localizing the processing regarding the distributed control into the interface layer situated subordinately to the application layer, the reusability of the application layer is improved. Also, by localizing the format conversion processing of the input data from the virtual sensor part and the output data to the virtual actuator part into the aforementioned input information conversion part and the output control part, it is made possible for the application layer to handle the aforementioned output data in a fixed format. As a result thereof, even if the sensor and actuator are modified and the format of the input data is modified, it is acceptable to modify only the aforementioned input information conversion part and the output control part, and the reusability of the application layer is improved.

However, in the prior art, there are cases where the application layer must be modified in case the format of the data transmitted and received through communication is modified. There is e.g. considered the case where a certain control device A transmits input data from a virtual sensor part to a control device B through communication. Even in the case where a sensor connected to control device A has been modified and the format of the input has changed, it is possible, by correcting the input information conversion part of control device A, to keep the data format transmitted to control device B the same as before the modification of the control device. As a result thereof, it is possible for the application layer of control device B to process the received data from control device A in a certain fixed format, so there is no need to modify the same application layer. However, in case the input information conversion part of control device A cannot be corrected for some reason, it becomes impossible for the application layer of control device B to effectuate processing with a fixed format, so the same application layer must be modified. As a reason for the above, there is e.g. the case that the manufacturers of control device A and control device B are different. In this case, in order to preserve the reusability of the application layer generated by the manufacturer of control device B, it is difficult to modify the input information conversion part of control device A made by a different manufacturer.

### SUMMARY OF THE INVENTION

The object of the present invention is to make it possible, even in the case where the format of the transmitted and received data is modified through communication, for the application layers on both the transmitting and receiving sides to effectuate processing in a certain fixed data format, and as a result thereof, to improve the reusability of the same application layers.

In order to implement the aforementioned object, there is chosen a software configuration in which a communication driver has a function of outputting the received data to an input information conversion part and the input information conversion part outputs the same data to an application layer in a format enabling processing by the application layer. Also, there is chosen a software configuration in which an output information conversion part (corresponding to the aforementioned output control part) is provided subordinately to the application layer; the output information conversion part has a function of outputting the transmitted data to the communication driver; the application layer outputs the same data to the output information conversion part; and the output information conversion part outputs the same through communication to the communication driver in a format making communication possible.

By means of the aforementioned configuration, even if the format of transmitted and received data is modified through communication, it becomes possible for the application layers on both the transmission and reception sides to effectuate processing in a certain fixed data format, so the reusability of the application layers is improved. Also, it comes about that the application layers input and output the transmitted and received data through communication from an input information conversion part and to an output information conversion part and not to and from a communication driver. Consequently, for an application layer, it is the same as if it is inputting and outputting data with respect to the sensor and actuator connected to its own control device. I.e., rather than providing an interface layer, positional transparency of sensors and actuators is implemented with respect to the application layer.

Other objects, features and advantages of the invention will become apparent from the following description of the embodiments of the invention taken in conjunction with the accompanying drawings.

### BRIEF DESCRIPTION OF THE DRAWINGS

FIG. 1 shows the data flow occurring in the case of receiving sensor information.

FIG. 2 is a hardware block diagram of a control unit.

FIG. 3 is a software block diagram of the first embodiment.

FIG. 4 shows the data flow occurring in the case of transmitting actuator information.

FIG. 5 shows an embodiment of an input information conversion part of a sensor driver.

FIG. 6 shows an embodiment of a data output function of a communication driver.

FIGS. 7A and 7B show an embodiment of the API of a sensor driver.

FIG. 8 shows an embodiment of an application program.

FIG. 9 shows an embodiment of an output information conversion part of an actuator driver.

FIG. 10 shows an embodiment of a data input function of a sensor driver.

FIGS. 11A and 11B show an embodiment of an actuator driver API.

FIG. 12 shows an embodiment of an application program.

FIG. 13 shows a software block diagram of the second embodiment.

FIG. 14 shows the data flow occurring in the case of receiving sensor information.

FIG. 15 shows the data flow occurring in the case of transmitting actuator information.

FIGS. 16A and 16B show an embodiment of a single conversion layer of a sensor driver.

FIGS. 17A and 17B show an embodiment of a physical quantity conversion layer of a sensor driver.

FIGS. 18A and 18B show an embodiment of a single conversion layer of an actuator driver.

FIG. 19 shows an embodiment of an output signal conversion layer of an actuator driver.

FIGS. 20A, 20B, and 20C show an embodiment of a single conversion layer and a module input/output description part of a sensor driver.

FIGS. 21A, 21B, and 21C show an embodiment of a single conversion layer and module input/output description part of an actuator driver.

FIG. 22 shows the software development procedure and development environment, of the third embodiment.

FIG. 23 shows an example of a module configuration table.

FIG. 24 shows a display screen example of a module input/output description part generating device.

### DESCRIPTION OF THE INVENTION

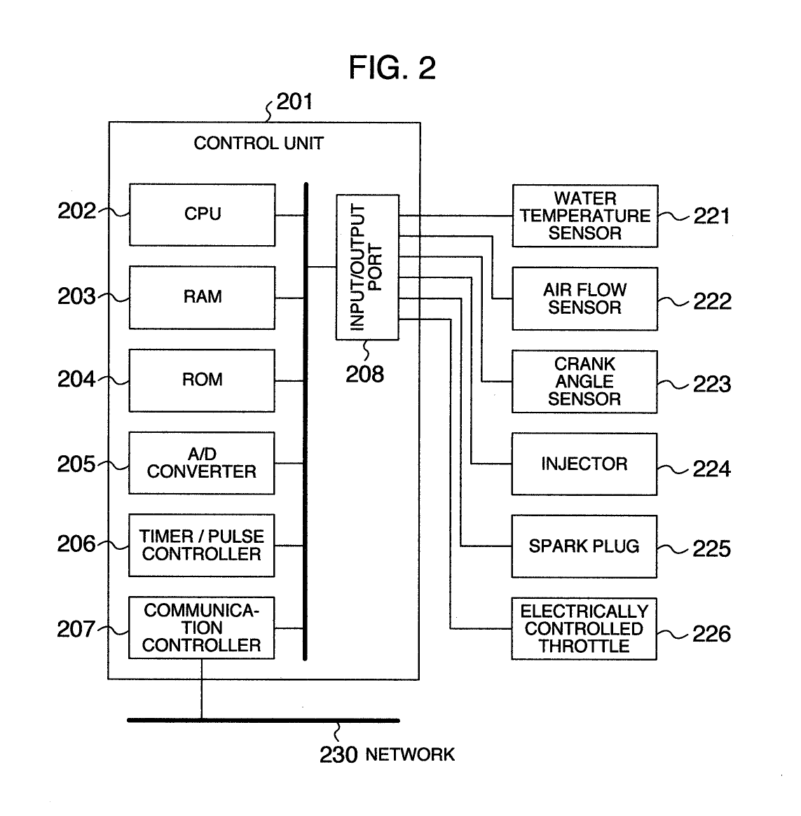

Hereinafter, there will be given an explanation regarding the embodiments of the present invention. FIG. 2 shows the general structure of a motor vehicle engine control device as an example of an electronic control device which is the object of the present invention. A control unit 201 consists of a CPU 202, a ROM 203, a RAM 204, an A/D converter 205, a timer/pulse controller 206, a communication controller 207, and an input/output port 208. To control unit 201, sensors such as a water temperature sensor 221, an air flow sensor 222, a crank angle sensor 223, and the like, and actuators such as an injector 224, a spark plug 225, and an electrically controlled throttle 226, are connected via input/output port 208, control unit 201 carrying out control of these. Communication controller 207 is connected to a network 210 such as CAN (Controller Area Network), making communication between control units possible. The software describing the procedures controlling these is loaded in ROM 203 and RAM 204 and is executed by means of CPU 202.

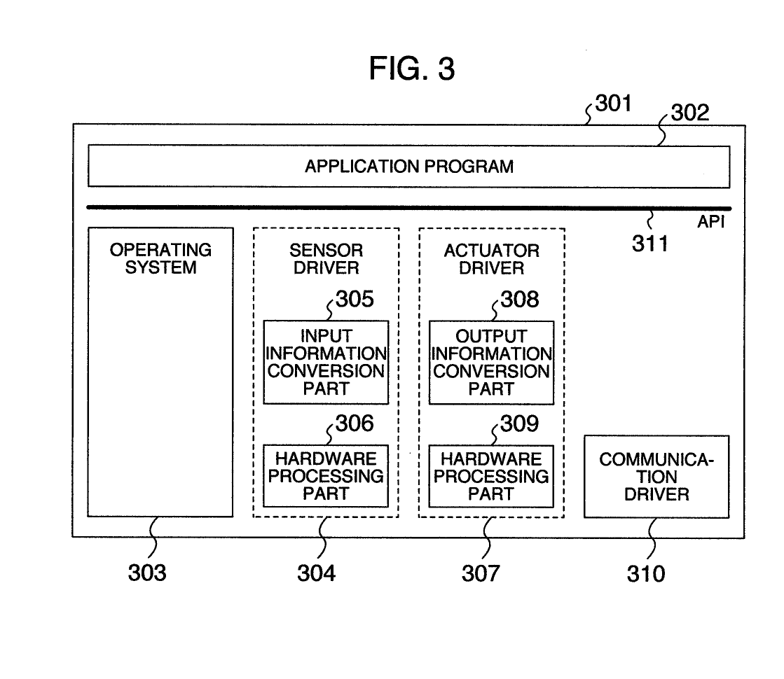

FIG. 3 shows the configuration of software 301 executed by means of CPU 202. The software is big and consists of an application program 302, an operating system 303, a sensor driver 304, an actuator driver 307, and a communication driver 310. Application program 302 carries out transfer of data and processing with respect to operating system 303, sensor driver 304, actuator driver 307, and communication driver 310, via an application programming interface API 311. Sensor driver 304 consists of an input information conversion part 305 and a hardware processing part 306 and actuator driver 307 consists of an output information conversion part 308 and a hardware processing part 309. As basic functions of sensor driver 304, there are those of converting, by hardware processing part 306, signals input via input/output port 208 from the sensors into a voltage value using A/D converter 205, and of converting, by input information conversion part 308, voltage values into physical values. Also, as basic functions of actuator driver 307, there are those of converting, by output information conversion part 308, the command quantities received via API 311 from application program 302 into output signals with respect to the actuators, and of outputting, by hardware processing part 309, the same signals to the actuators via input/output port 208.

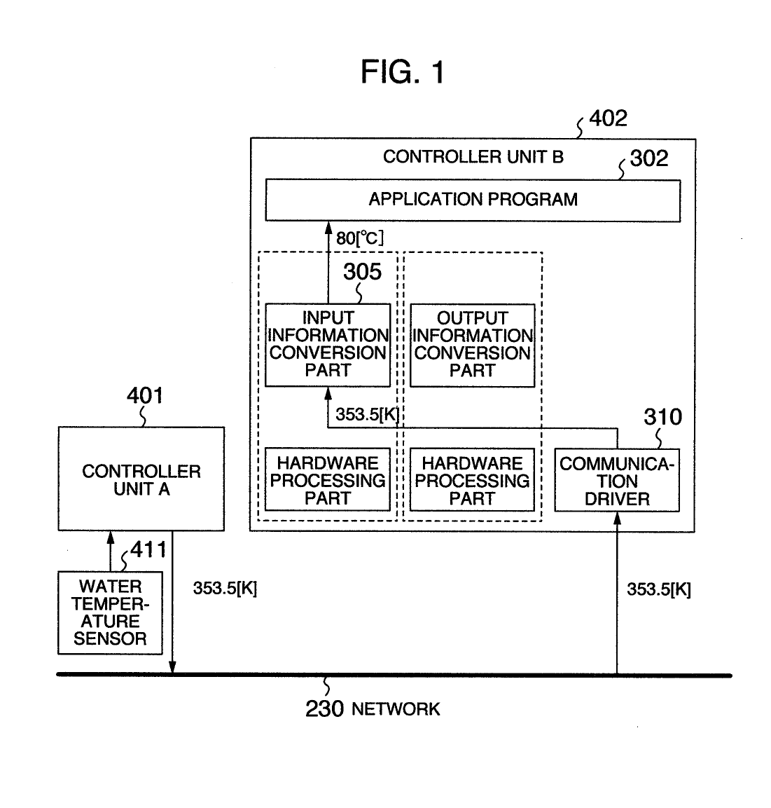

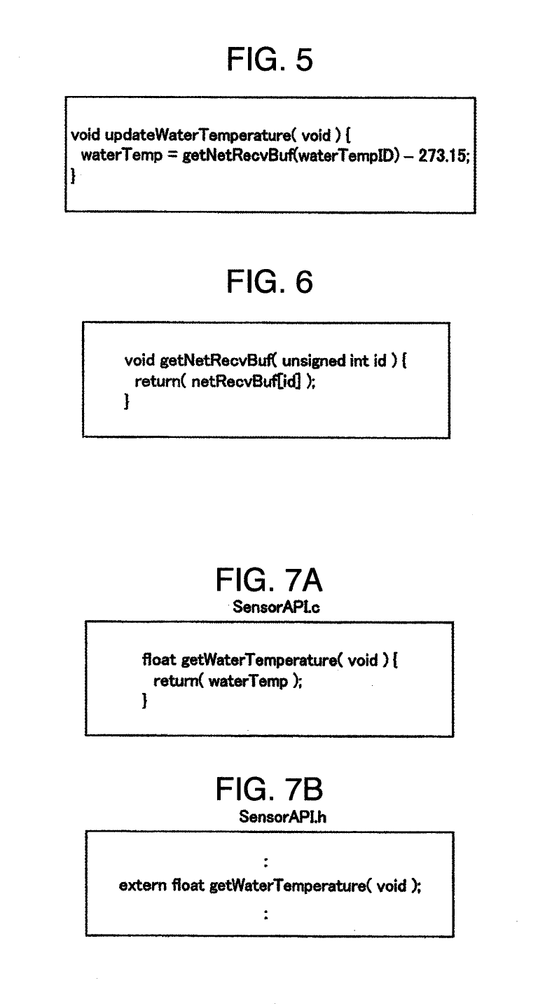

As basic functions of the sensor driver and the actuator driver, there are those as stated above but in the present invention, as shown in FIG. 1 and FIG. 5, they have a function of inputting and outputting data with respect to the communication driver. FIG. 1 shows the situation in which a physical water temperature value from a water temperature sensor 411 connected to a controller unit A 401 is transmitted to a controller unit B 402 via a network 230. Here, as a first assumption, it is taken that the software of controller unit A 401 is such that it can for some reason not be changed. There can e.g. be cited as the aforementioned reason, as mentioned above, the case that controller unit A 401 is made by another manufacturer. As a second assumption, it is taken that controller unit A 401 is one that, regarding the physical water temperature value obtained from water temperature sensor 411, transmits the same as a physical water temperature value with units in Kelvin (K) and that application program 302 of controller unit B 402 handles the units of the physical water temperature value obtained from the water temperature sensor in degrees Celsius (° C.). In this case, the physical water temperature value transmitted by controller unit A 401 via a communication driver is received in controller unit B 402 by means of communication driver 310 and is transferred to input information conversion part 305. Input information conversion part 305 converts the units of the physical water temperature value input from communication driver 310 from degrees Kelvin (K) into degrees Celsius (° C.), so that application program 302 can handle the physical water temperature value in degrees Celsius (° C.) and transfers the same to application program 302. In this way, it becomes unnecessary to modify application program 302 of controller unit B 402 receiving the same and as a result, it becomes possible to improve the reusability thereof. Also, since application program 302 is inputting the physical water temperature value from input information conversion part 305 of the sensor driver, it is the same as obtaining the physical water temperature value from the water temperature sensor connected to controller unit B 402.

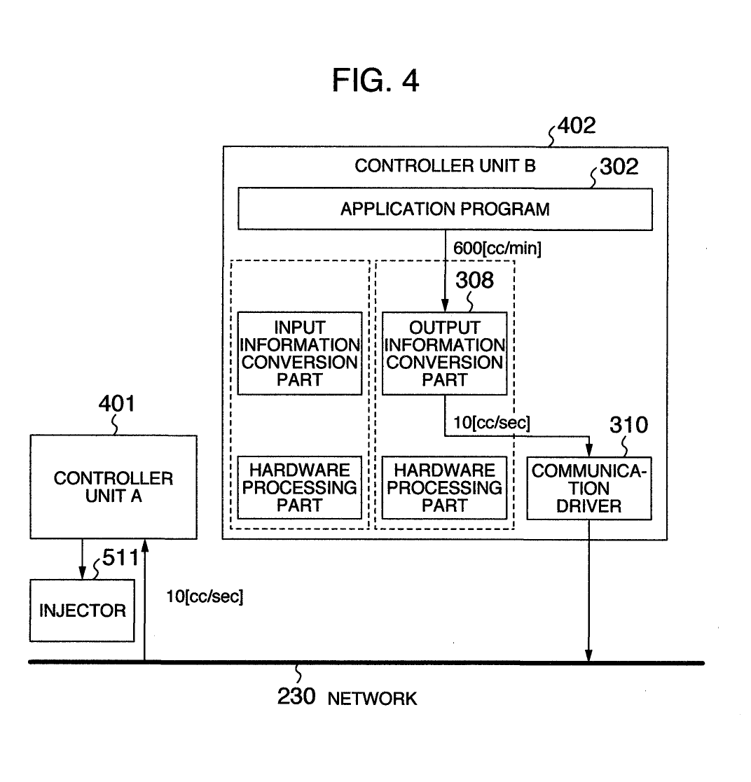

FIG. 4 shows a situation in which an injection quantity is transmitted with respect to an injector 511 connected to controller unit A 401 as an instruction value, from controller unit B 402 via network 230. Here, similarly to the case of FIG. 1, it is taken as a first assumption that, for some reason, the software of controller unit A 401 cannot be changed. It is taken as a second assumption that controller unit A 401 handles the units of the injection quantity received as the instruction value with respect to injector 511 in cubic centimeters per second (cc/sec) and that application program 302 of controller unit B 402 handles the units of the injection quantity instructed to injector 511 in cubic centimeters per minute (cc/min). In this case, in controller unit B 402, output information conversion part 308 converts the units of the injection quantity received from application program 302 from cubic centimeters per minute (cc/min) to cubic centimeters per second (cc/sec) and makes a transfer to communication driver 310. Consequently, controller unit A 401 can receive injection quantity data in units of cubic centimeters per second (cc/sec). In this way, there is no need to modify, in controller unit B 402, application program 302 which transfers the injection quantity in units of cubic centimeters per minute (cc/min) and as a result, it becomes possible to improve the reusability thereof. Also, since application program 302 outputs the injection quantity to output information conversion part 308 of the actuator driver, it is the same as outputting the injection quantity to the injector connected to controller unit B 402, so positional transparency of the injector is implemented.

FIG. 5 shows an example in which input information conversion part 305 of the sensor driver is implemented in the C language. The getNetRecvBuf( ) function is a function provided by communication driver 310 and in this example, the example is one of program code acquiring the data received by means of communication driver 310 using getNetRecvBuf( ) on the basis of “waterTempID” and converting the units of the physical water temperature value from degrees Kelvin (K) into degrees Celsius (° C.).

FIG. 6 shows an example of a communication driver function, implemented in the C language, providing received data from communication driver 310 to sensor driver 304. In this example, there is shown an example in which the communication driver stores received data in a buffer netRecvBuf( ). Further, as for the method of storing the data received by means of the communication driver in netRecvBuf( ), there are e.g. the method of using interrupts and the method of using polling.

FIGS. 7A and 7B show an example of a sensor driver API implemented in the C language. FIG. 7A shows the body of the API and FIG. 7B shows the header file. An application program, as shown in FIGS. 7A and 7B, includes the header file “SensorAPI.h” and by calling these API functions, various physical values are obtained. As shown in FIGS. 7A and 7B, the application program is able to acquire, in identical formats, a physical value coming from a sensor connected to its own controller unit and a physical value received through communication.

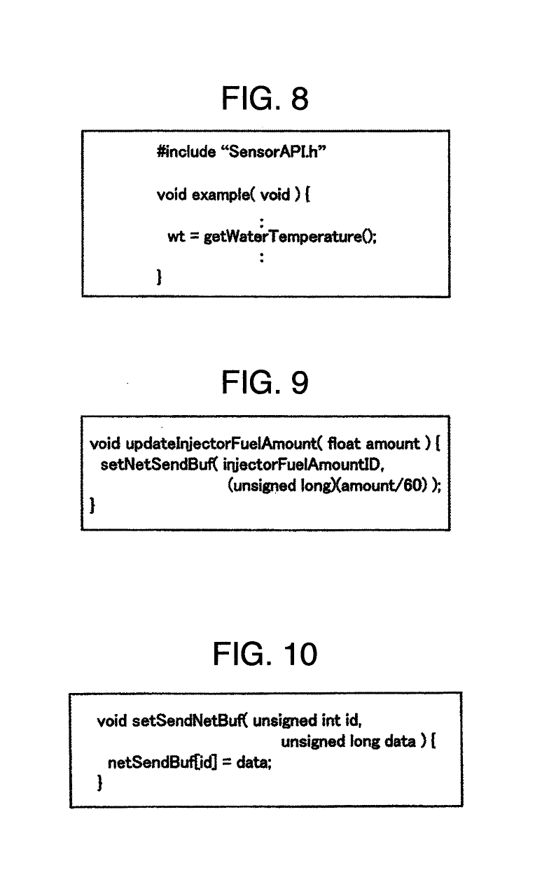

FIG. 8 shows an example of program code in which an application program, acquiring physical water temperature values and carrying out some processing, has been implemented in the C language. Even if the format of a physical water temperature value received through communication is modified, it is acceptable, by modifying the input information conversion part of the sensor driver such as shown in FIG. 5, not to modify an application program such as shown in FIG. 8 which handles the physical water temperature value in a certain fixed format. Also, even in the case where the water temperature sensor is connected to its own controller unit, since the API of the sensor driver does not change, it is acceptable not to modify the code of the application program.

FIG. 9 shows an example in which output information conversion part 308 of the actuator driver is implemented in the C language. The setNetSendBuf( ) function is one provided by communication driver 310, and in this example, the example is one of program code converting the units of the injection quantity, received from the application program as an instruction with respect to the injector, from cubic centimeters per minute (cc/min) into cubic centimeters per second (cc/sec) and outputting the same to the communication driver, using the setNetSendBuf( ) function on the basis of “injectorFuel AmountID”. Further, as for the conversion due to the output information conversion part, there may e.g. be the case where operating system 303 is executed by means of a task activated with a certain period, the case where it is executed by means of communication driver 310, the case where it is executed by means of an application program through an API, and the like.

FIG. 10 shows an example in which the aforementioned setNetSendBuf( ) function, receiving transmitted data from an actuator driver, is implemented in the C language. In this example, there is shown the case in which the communication driver stores the transmitted data in the buffer netSendBuf[ ]. The communication driver shapes the data stored in netSendBuf[ ] into a data format compliant with the communication protocol and transmits them to a specific control device with timing that is compliant with the same communication protocol.

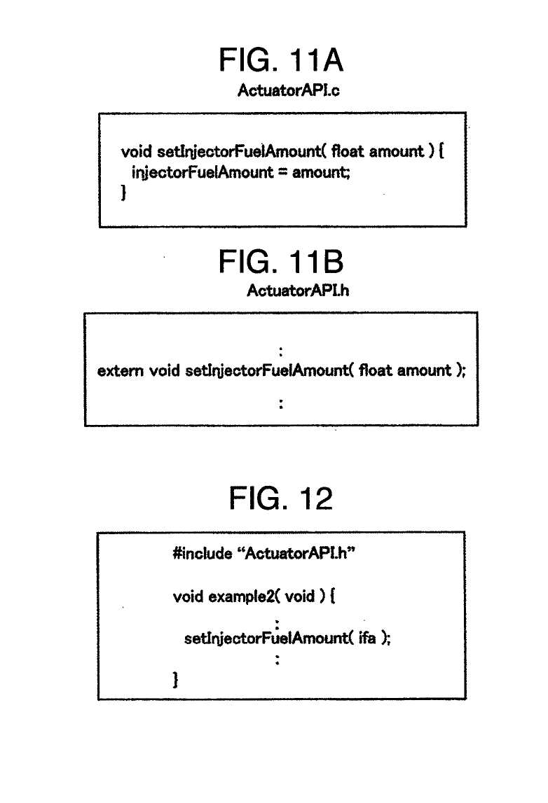

FIGS. 11A and 11B show an example in which the API of the actuator driver is implemented in the C language. FIG. 11A shows the body of the API and FIG. 11B shows the header file. The application program includes the header file “ActuatorAPI.h”, as shown in FIG. 12, and by calling these API functions, various instruction values are output to the actuator driver. As shown in FIG. 12, the application program can output the instruction value to the actuator connected to its own controller unit and the instruction value transmitted through communication in the same format.

FIG. 12 shows an example of program code in which an application program, which carries out some processing while outputting an injection quantity as an instruction value to the injector, is implemented in the C language. Even if the format of the injection quantity transmitted through communication is modified, by modifying the output information conversion part of the actuator driver such as shown in FIG. 9, it is acceptable not to modify the application program such as shown in FIG. 12, which handles the injection quantity in a certain fixed format. Also, even in the case where the injector is connected to its own controller unit, it is acceptable, since the API of the actuator driver does not change, not to modify the code of the application program.

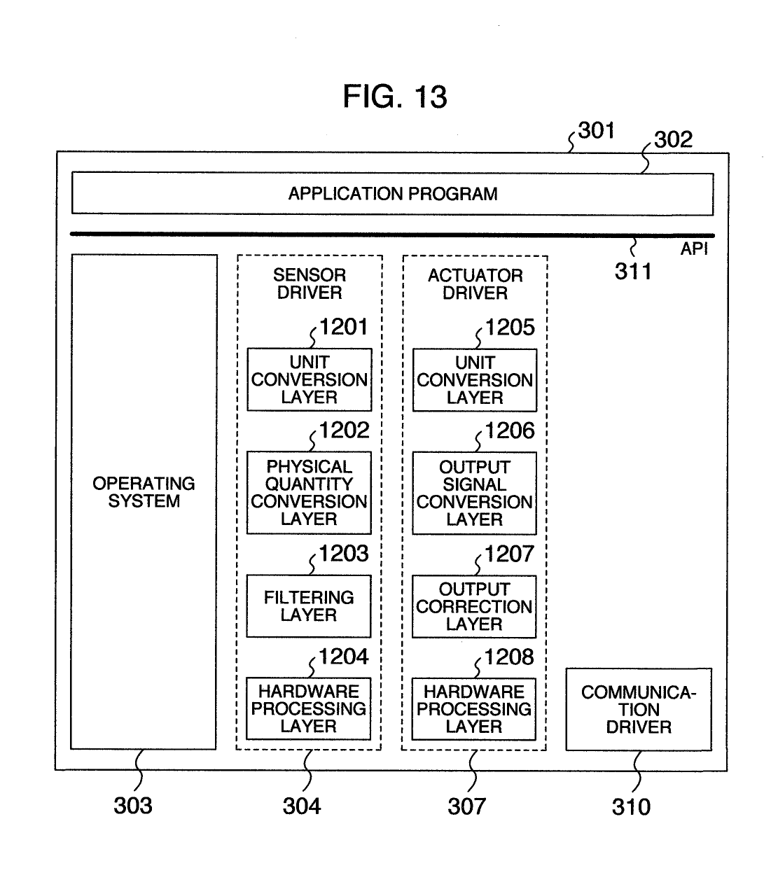

FIG. 13 shows the structure of software 301 in the case where sensor driver 304 and actuator driver 307 are configured in three or more layers. In the present embodiment, sensor driver 304 consists of four layers, a unit conversion layer 1201, a physical quantity conversion layer 1202, a filtering layer 1203, and a hardware processing layer 1204; and actuator driver 307 consists of four layers, a unit conversion layer 1205, an output signal conversion layer 1206, an output correction layer 1207, and a hardware processing layer 1208. As basic functions of each layer of sensor driver 304, hardware processing layer 1204 converts a signal input via input/output port 208 from the sensor to a voltage value using A/D converter 205, filtering layer 1203 carries out filtering processing related to the noise with respect to the aforementioned voltage value, physical quantity conversion part 1202 makes a conversion into a physical quantity from the voltage value for which the filtering processing has been completed, and unit conversion layer 1201 converts the units of the physical quantity. Also, as basic functions of each layer of actuator driver 307, unit conversion layer 1205 converts the units of the instruction value received via API 311 from application program 302, output signal conversion layer 1206 converts the aforementioned instruction value into an output signal with respect to the actuator, output correction layer 1207 corrects the aforementioned output signal in response to the various states targeted for control, and hardware processing layer 1208 outputs said output for which correction has been completed to the actuator via input/output port 208.

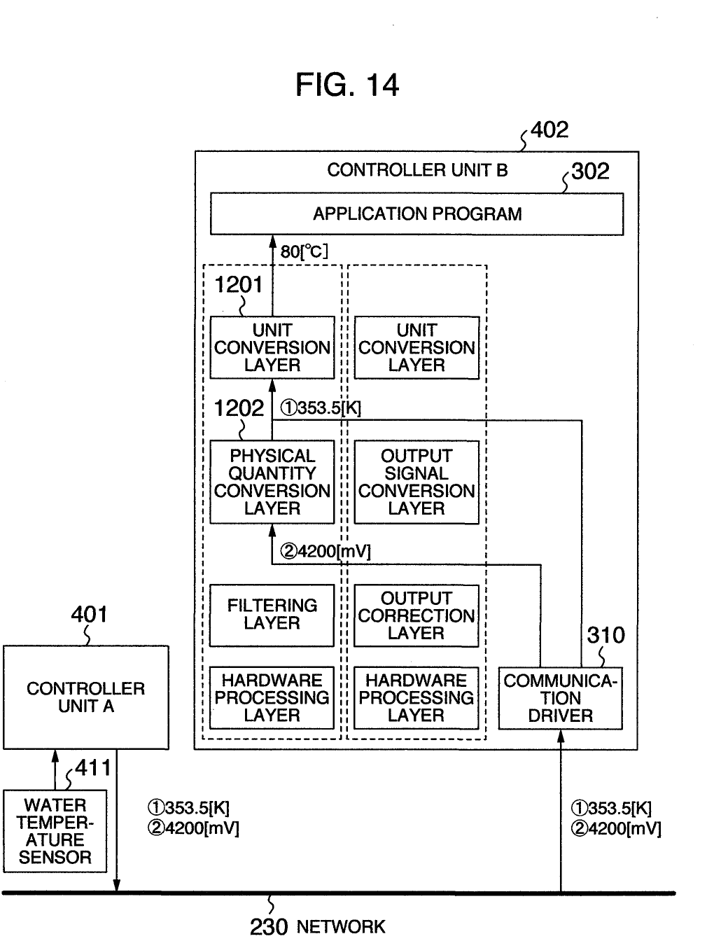

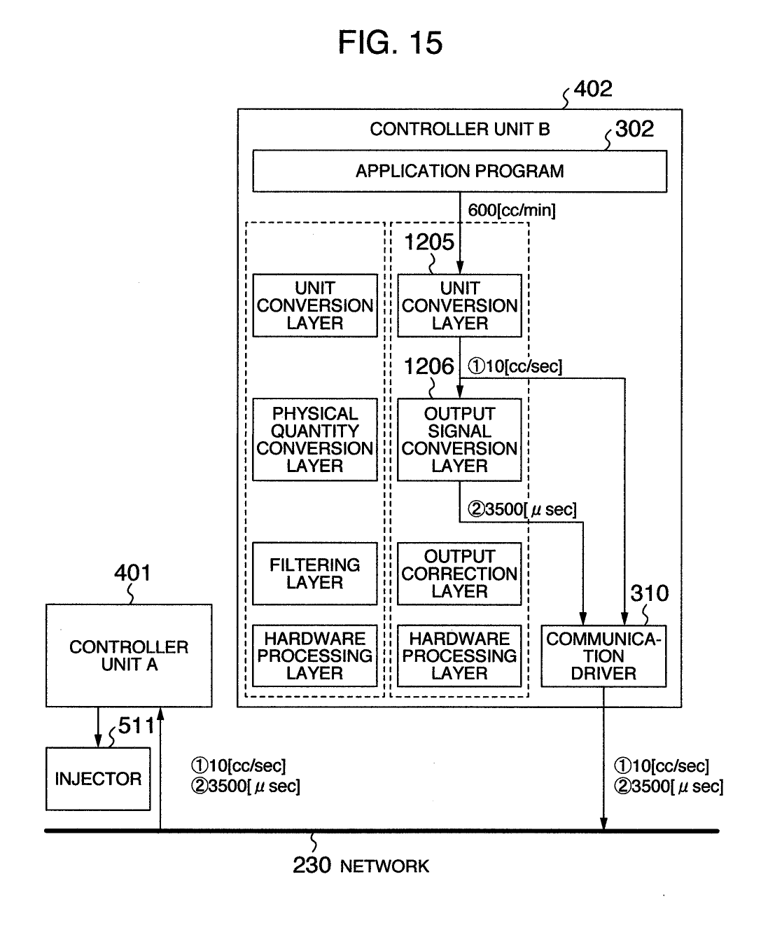

As basic functions of the various layers of the sensor driver and the actuator driver, they are as described above, but in the present invention each layer also has a function of inputting and outputting data with respect to the communication driver, as shown in FIG. 14 and FIG. 15. FIG. 14 shows a situation in which data related to water temperature sensor 411 connected to controller unit A 401 are transmitted via network 230 to controller unit B 402. Here, in the same way as in Embodiment 1, it is taken as a first assumption that the software of controller unit A 401 can for some reason not be modified. It is taken as a second assumption that application program 431 of controller unit B 402 handles the units of physical water temperature values obtained from the water temperature sensor in degrees Celsius (° C.). And then, there will hereinafter be given a description of the embodiment regarding two cases, the cases in which the data related to water temperature sensor 411, transmitted from controller unit A 401, are (1) a physical water temperature value in units of degrees Kelvin (K) and (2) a voltage value in units of millivolts (mV). (Further, it is taken that what is indicated by (1) in the main text corresponds to what is indicated by an encircled “1” in the drawings.) In the case of (1), the physical water temperature value transmitted by controller unit A 401 via communication driver is received in controller unit B 402 by means of communication driver 310. Here, since, in order to handle the received data with application program 302, it is acceptable just to convert the units thereof, the received data are transferred to unit conversion layer 1201. Unit conversion layer 1201 converts the units of the physical water temperature value input from communication driver 310 from degrees Kelvin (K) into degrees Celsius (° C.) and makes a transfer to application program 302. In this way, the need is eliminated to modify application program 431 of controller unit B 402, having degrees Kelvin as working units and receiving the physical water temperature value, and as a result, it becomes possible to improve the reusability thereof. Also, since application program 431 inputs the physical water temperature value from the sensor driver, it is the same as obtaining the physical water temperature value from the water temperature sensor connected to controller unit B 402, so positional transparency of the water temperature sensor is implemented. Next, in the case of (2), a voltage value transmitted by controller unit A 401 via the communication driver is received in controller unit B 402 by means of communication driver 310. Here, since there is a need, in order that the received data can be handled with application program 302, to convert the same to a physical water temperature value, they are transferred to physical quantity conversion layer 1202. Physical quantity conversion layer 1202 converts the voltage value input from communication driver 310 to a physical water temperature value and the value is transferred to unit conversion layer 1201. And then, finally, the physical water temperature value with units in degrees Celsius (° C.) is transferred to application program 302. In this way, even in the case where a voltage value is received, an improvement in the reusability of application program 431 of controller unit B 402 as well as positional transparency of the water temperature sensor is implemented, in the same way as in (1).

FIG. 15 shows the situation in which an injection quantity is transmitted as an instruction value from controller unit B 402 via network 230 with respect to an injector 511 connected to controller unit A 401. Here, similarly to the case of FIG. 14, it is taken as a first assumption that the software of controller unit A 401 can for some reason not be modified. And then, it is taken as a second assumption that application program 302 of controller unit B 402 handles the units of the injection quantity instructed to injector 511 in cubic centimeters per minute (cc/min). And then, there will hereinafter be given a description of the embodiment regarding two cases, the cases in which the data with respect to injector 511, received by controller unit A 401, are (1) an injection quantity in units of cubic centimeters per second (cc/sec) and (2) a pulse width in units of microseconds (psec). In the case of (1), unit conversion layer 1205 converts, in controller unit B 402, the units of the injection quantity received from application program 302 from cubic centimeters per minute (cc/min) into cubic centimeters per second (cc/sec). At this moment, since it has been possible to make a conversion into a data format accepted by controller unit A 401, a transfer is made to communication driver 310. Consequently, controller unit A 401 is able to receive injection quantity data having units in cubic centimeters per second (cc/sec). In this way, the need is eliminated, in controller unit B 402, to modify application program 302 transferring injection quantities with units in cubic centimeters per minute (cc/min) to the output information conversion part, and as a result, it becomes possible to improve the reusability thereof. Also, since application program 302 outputs the injection quantity to output information conversion part 1205 of the actuator driver, it is the same as outputting the injection quantity to the injector connected to controller unit B 402, so positional transparency of the injector is implemented.

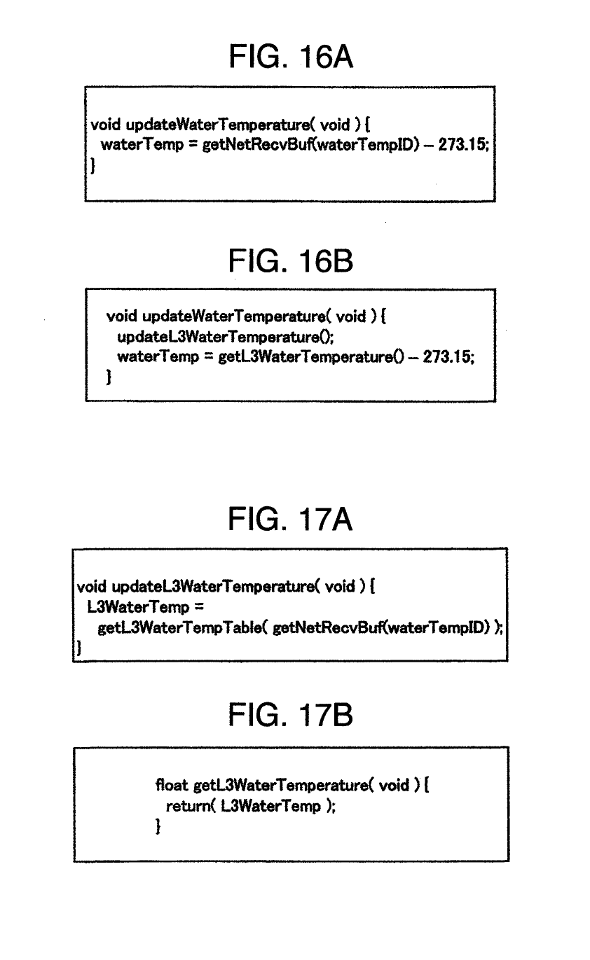

FIGS. 16A and 16B show an example in which unit conversion layer 1201 of the sensor driver is implemented in the C language. FIG. 16A is an implementation example in the case (1) where, regarding data related to water temperature sensor 411 and transmitted from controller unit A 401 in FIG. 15, the data are a physical water temperature value with units in degrees Kelvin (K). The getNetRecvBuf( ) function is a function provided by the communication driver and in this example, the example is one of program code acquiring the data received by means of the communication driver using the getNetRecvBuf( ) on the basis of “waterTempID” and converting the units of the physical water temperature value from degrees Kelvin (K) into degrees Celsius (° C.). Moreover, FIG. 16B is an implementation example in the case (2) where the data are a voltage value with units in millivolts (mV). The updateL3WaterTemperature( ) function is a function activating conversion processing, with respect to physical quantity conversion layer 1202, from a voltage value into a physical value. Also, the getL3WaterTemperature( ) function is a function activating conversion processing, with respect to physical quantity conversion layer 1202, from a voltage to a physical value. In this example, the example is one of program code converting the units of the physical water temperature value acquired from physical quantity conversion layer 1202 from degrees Kelvin (K) into degrees Celsius (° C.).

FIGS. 17A and 17B show an example in which physical quantity conversion layer 1202 of the sensor driver, occurring in the case (2) in FIG. 14 of a voltage value with units in millivolts (mV), is implemented in the C language. FIG. 17A is an implementation example of the updateL3WaterTemperature( ) function converting a voltage value from the water temperature sensor into a physical water temperature value. The getL3WaterTempTable( ) function is a function acquiring a physical value from a map table on the basis of a voltage value. FIG. 17B is an implementation example of the getL3WaterTemperature( ) function providing a physical water temperature value to unit conversion layer 1201.

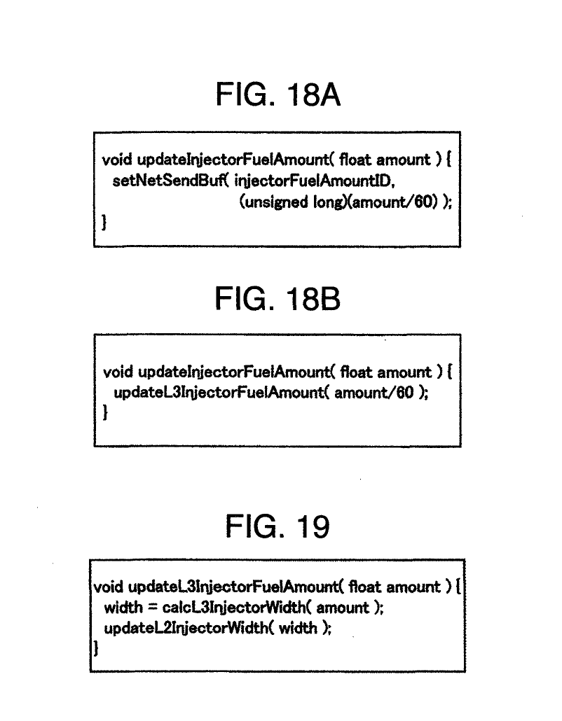

FIGS. 18A and 18B show an example in which unit conversion layer 1205 of the actuator driver is implemented in the C language. FIG. 18A is an implementation example occurring in the case (1) where, regarding the data with respect to injector 511, received by controller unit A 401 in FIG. 15, the data are an injection quantity with units in cubic centimeters per second (cc/sec). The setNetSendBuf( ) function is one provided by communication driver 310 and in this example, the example is one of program code converting the units of the injection quantity, received from the application program as an instruction with respect to the injector, from cubic centimeters per minute (cc/min) into cubic centimeters per second (cc/sec) and outputting the same to the communication driver, using the setNetSendBuf( ) function on the basis of “injectorFuelAmountID”. FIG. 18B is an implementation example occurring in the case (2) of pulse width in units of microseconds (μ sec). The updateL3InjectorFuelAmount( ) function is a function activating conversion processing from the injection quantity with respect to output signal conversion layer 1206 to pulse width. In this example, the example is one of program code converting the units of the injection quantity, received from the application program as an instruction with respect to the injector, from cubic centimeters per minute (cc/min) into cubic centimeters per second (cc/sec) and outputting the same to output signal conversion layer 1206.

FIG. 19 is an implementation example in which output signal conversion layer 1206 of the actuator driver, occurring in the case where, regarding the data with respect to injector 511, received by controller unit A 401 in FIG. 15, the data are a pulse width with units (2) in microseconds (μ sec), is implemented in the C language. In this example, the example is one of program code calculating the pulse width from the injection quantity, using the calcL3InjectorWidth( ) function, and outputting the aforementioned pulse width using the updateL2InjectorWidth( ) function to output correction layer 1207.

Further, in the present embodiment, the program code examples in which the API and the application program of the sensor driver and the actuator driver are implemented in the C language work out to being the same as in Embodiment 1. Also, in the present embodiment, there have only been shown implementation examples of unit conversion layer 1201 and physical quantity conversion layer 1202 of the sensor driver and unit conversion layer 1205 and output signal conversion layer 1206 of the actuator driver, but the implementation method for filtering layer 1203 and hardware processing layer 1204 of the sensor driver and for output correction layer 1207 and hardware processing layer 1208 of the actuator driver is the same.

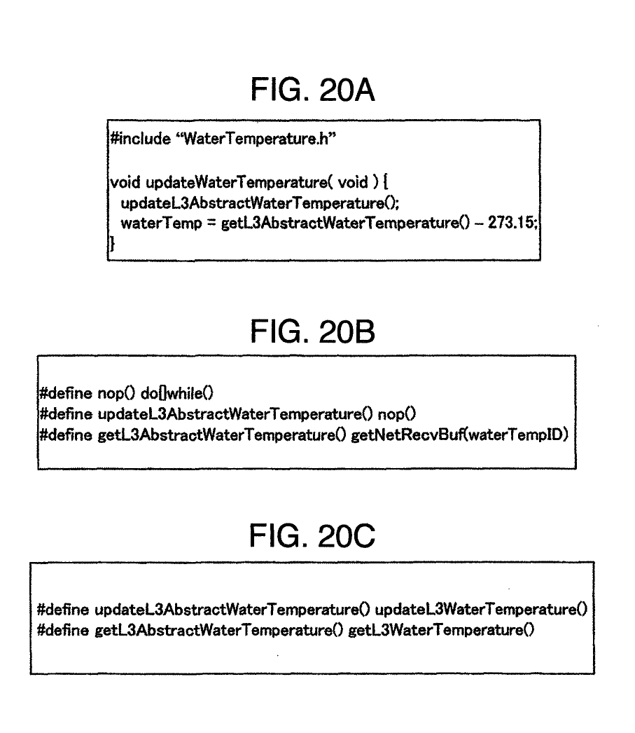

FIGS. 20A to 20C are separate examples in which unit conversion layer 1201 of the sensor layer occurring in Embodiment 2 is implemented in the C language. In Embodiment 1, as shown in FIG. 16, depending on whether it was (1) a case of a physical water temperature value with units in degrees Kelvin (K) or (2) a case of a voltage value with units in millivolts (mV), there was a need to modify the unit conversion layer. FIG. 20 is an implementation example in which the need for such a modification, regarding the unit conversion layer, has been removed. FIG. 20A is an example of program code where a unit conversion layer has been implemented. Here, unit conversion is carried out using the updateL3AbstractWaterTemperature( ) function and the getL3AbstractWaterTemperature( ) function. As for these functions, it is necessary to carry out the processing of acquiring the physical value from communication driver 310 in the aforementioned case (1) and, moreover, to carry out the processing of acquiring the physical value from physical quantity conversion layer 1202 in the aforementioned case (2). Accordingly, as shown in FIGS. 20B and 20C, there is described the concrete processing content of the aforementioned functions using C language macros. These are called module input/output description parts. In this example, “WaterTemperature.h” is one of the module input/output description parts. FIG. 20B shows the module input/output description part of the water temperature sensor driver occurring in the aforementioned case (1). The source code of FIG. 20A, by including “WaterTemperature.h” which is a module input/output description part, becomes the same function as that of FIG. 16A, by means of a C language compiler. Moreover, FIG. 20C shows the module input/output description part of the water temperature sensor driver occurring in the aforementioned case (2). In this way, the source code of FIG. 20A becomes the same function as that of FIG. 16B, by means of a C language compiler.

Further, like the updateL3AbstractWaterTemperature( ) function mentioned above, a function by which conversion is made to concrete processing content by means of the C language macros described in the module input/output description part will hereinafter be called an abstract function.

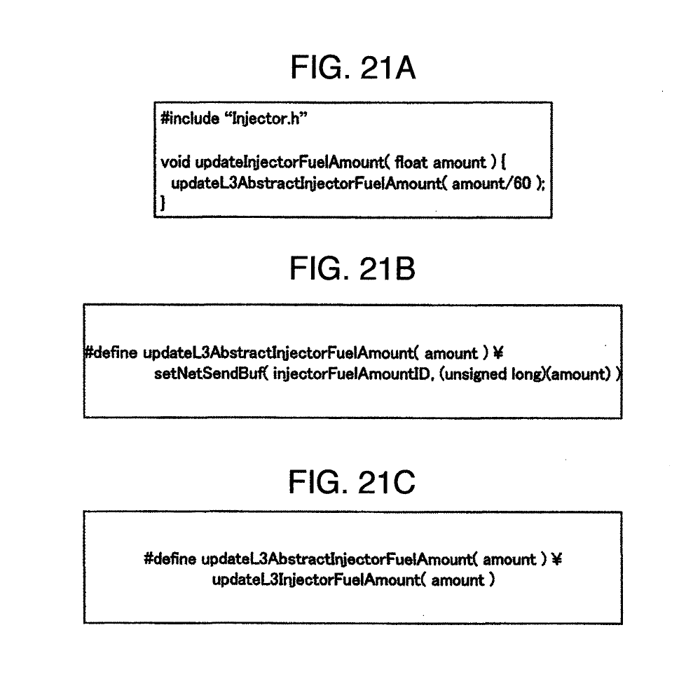

FIGS. 21A to 21C are separate examples in which unit conversion layer 1205 of the actuator driver occurring in Embodiment 2 is implemented in the C language. In Embodiment 2, as shown in FIGS. 17A and 17B, depending on whether it was a case (1) of an injection quantity with units in cubic centimeters per second (cc/sec) or a case (2) of a pulse width with units in microseconds (μ sec), there was a need to modify the unit conversion layer. FIGS. 21A to 21C show an example of an implementation in which, regarding the unit conversion layer, the need for modification thereof has been eliminated. FIG. 21A shows program code by which a unit conversion layer is implemented using an abstract function and FIGS. 21B and 21C respectively show “Injector.h” program code serving as module input/output description parts in the case of the aforementioned cases (1) and (2).

As mentioned above, by providing a module input/output description part together with implementing each layer of the sensor driver and the actuator driver using abstract functions, there is no need, even in the case where the format of data transmitted and received through communication is modified, to modify each aforementioned layer, it being acceptable to modify only the module input/output description parts.

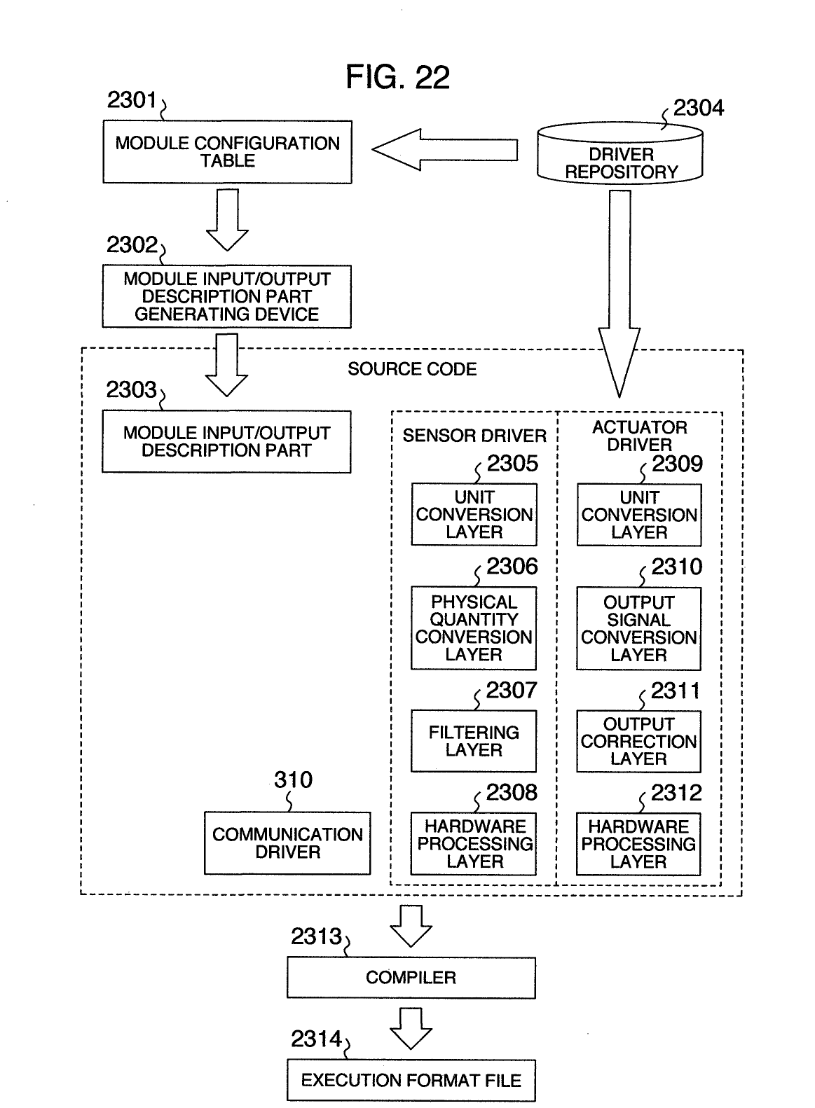

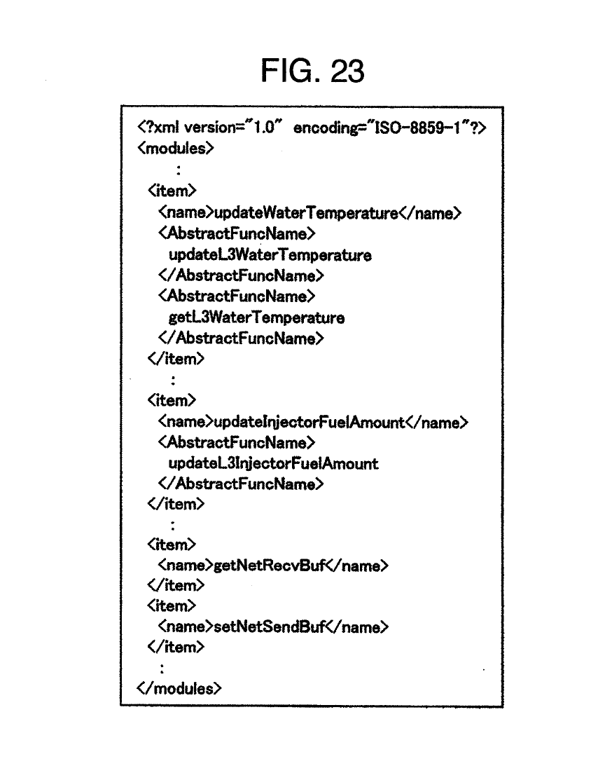

FIG. 22 shows an example of a software development procedure and a development environment, occurring in the case of providing a module input/output description part. Driver component groups (310, 2305 to 2312) for which generation such as shown in FIGS. 20A and 21A has been completed are registered and saved in a driver repository 2304. The driver component groups needed during software development are acquired from the aforementioned driver repository 2304. A module input/output description part 2303 is generated as follows. First, a module configuration table 2301 is generated on the basis of the driver component groups registered in driver repository 2304. The module configuration table is configured with a summary of the names of the functions affiliated with each driver component and the abstract functions used by the same functions and are e.g. described with XML such as shown in FIG. 23. Next, using a module input/output description part generating device 2302, a module input/output description part 2303 is generated on the basis of module configuration table 2301. Module input/output description part generating device 2302 determines, by receiving the settings of the input/output relationships between the driver components from the software developer, the same input/output relationships and generates module input/output description part 2303, on the basis of module configuration table 2301. In the end, driver component groups 310 and 2305 to 2312 acquired from driver repository 2304, as well as module input/output description part 2303, are compiled using a compiler 2313, and an execution format file 2314 is obtained. Further, module input/output description part generating device 2302, driver repository 2304, and compiler 2313 can e.g. be implemented using computers provided with input means such as a keyboard, a mouse, and a network; display means such as a CRT (Cathode Ray Tube); and storage means such as a hard disk.

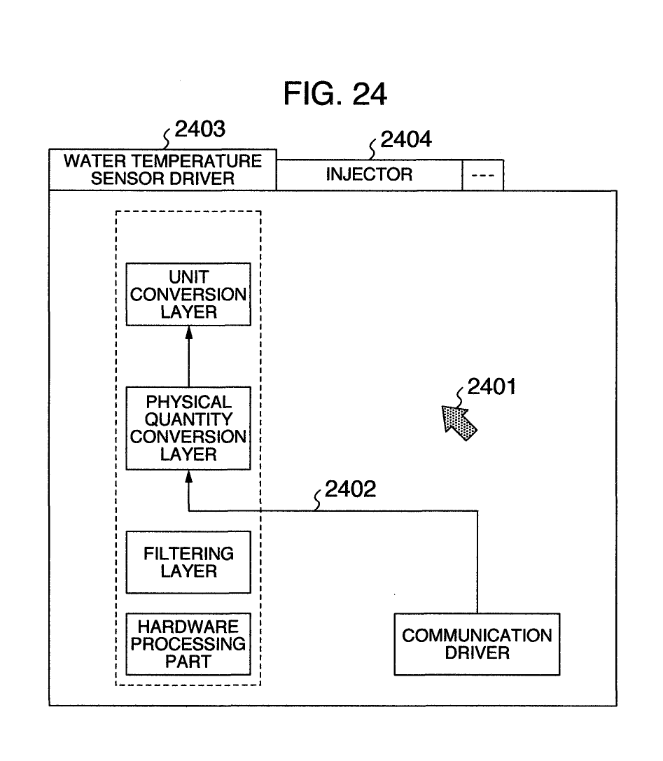

FIG. 24 shows a display screen example in which module input/output description part generating device 2302 receives, on the basis of module configuration table 2301, the settings of the input/output relationships between the driver components from the software developer. A setting screen 2403 of the water temperature sensor driver, a setting screen 2404 of the injector driver, and the like, are selectable by tabulation, and the software developer makes connections between the driver components by manipulating, with a pointer 2401 such as a mouse, an arrow 2402 expressing the input/output relationships between the driver components, and the like. Module input/output description part generating device 2302 displays, on the basis of module configuration table 2301, a screen such as shown in FIG. 24 and, after receiving a manipulation due to the software developer, receives the input/output relationships between the driver components on the basis of the aforementioned arrow 2402 making the connections between the driver components.

It should be further understood by those skilled in the art that although the foregoing description has been made on embodiments of the invention, the invention is not limited thereto and various changes and modifications may be made without departing from the spirit of the invention and the scope of the appended claims.

1. A control device having:
a communication part sending and receiving data via network;
a signal processing part inputting from sensors and/or outputting to actuators;
and a storage part storing an application program computing based on data from said communication part and said signal processing part, a first device driver controlling said communication part, and a second device driver controlling said signal processing part;
wherein said first device driver outputs data received via network to said second device driver, and said second device driver converts the data received from said first device driver into the same format as that of input data from said signal processing part and has a function of outputting the converted data to said application program.

2. The control device according to claim 1, wherein
said second device driver consists of a plurality of layers and said first device driver has a function of outputting data received by said communication part to one of the layers of second device driver according to conversion levels of the data.

3. A development system developing the control device according to claim 1,
having a module input/output description part describing the input/output relationships between the software components and outputting a module input/output description part, taking a module configuration table listing a summary of software components and assignments of the input/output relationships between the software components as inputs.

4. A control device having:
a communication part sending and receiving data via network;
a signal processing part inputting from sensors and/or outputting to actuators;
and a storage part storing an application program computing based on data from said communication part and said signal processing part, a first device driver controlling said communication part, and a second device driver controlling said signal processing part;
wherein said second device driver converts data input from said application program into the same format as that of data transmitted by said communication part and outputs the same to said first device driver; and
said first device driver has a function of transmitting, by means of said communication part, the data input from said second device driver.

5. The control device according to claim 4, wherein said second device driver consists of a plurality of layers and said second device driver has a function of outputting, to said first device driver, data input from the application program, from layers converting the data into the same format as that of data transmitted by means of said communication part.

6. A development system developing the control device according to claim 4, having a module input/output description part describing the input/output relationships between the software components and outputting a module input/output description part, taking a module configuration table listing a summary of software components and assignments of the input/output relationships between the software components as inputs.
